(19) United States
(12) Patent Application Publication
(10) Pub. No.: US 2012/0114054 A1
(43) Pub. Date: May 10, 2012

(54) Systems and Methods for Low-Complexity Max-Log MIMO Detection

(75) Inventors: Deric W. Waters, Dallas, TX (US); Anuj Batra, Dallas, TX (US)

(73) Assignee: TEXAS INSTRUMENTS INCORPORATED, Dallas, TX (US)

(21) Appl. No.: 13/285,222

(22) Filed: Oct. 31, 2011

Related U.S. Application Data
(63) Continuation-in-part of application No. 12/062,347, filed on Apr. 3, 2008, now Pat. No. 8,059,764.
(60) Provisional application No. 60/912,312, filed on Apr. 17, 2007.

(51) Int. Cl. H04L 27/28

(52) U.S. Cl. 375/260

(57) ABSTRACT

Embodiments provide novel systems and methods for multiple-input multiple-output (MIMO) Max-Log detection. These systems and methods enable near-optimal performance with low complexity for a two-input two-output channel. Some embodiments comprise using a Max-Log detector to compute a set of log-likelihood ratio (LLR) values for a channel input by minimizing cost function while computing only one instance of the cost function for each value of each bit in a symbol. Other embodiments comprise using a Max-Log detector to compute a set of log-likelihood ratio (LLR) values for a channel input by computing all instances of a cost function for each value of each bit in a symbol and selecting the minimum cost from all computed instances of the cost function for each value of each bit.

### CROSS-REFERENCE TO RELATED APPLICATIONS

The present application is a Continuation-in-Part of and claims priority to U.S. patent application Ser. No. 12/062,347 filed on Apr. 3, 2008 and issued on Nov. 15, 2011, U.S. Pat. No. 8,059,764. Said application claims priority to U.S. provisional patent application Ser. No. 60/912,312, filed Apr. 17, 2007 and entitled “Low-Complexity Max-Log MIMO Detector”, hereby incorporated herein by reference.

### BACKGROUND

As consumer demand for high data rate applications, such as streaming video, expands, technology providers are forced to adopt new technologies to provide the necessary bandwidth. Multiple-Input Multiple-Output (“MIMO”) is an advanced radio system that employs multiple transmit antennas and multiple receive antennas to simultaneously transmit multiple parallel data streams. Relative to previous wireless technologies, MIMO enables substantial gains in both system capacity and transmission reliability without requiring an increase in frequency resources.

MIMO systems exploit differences in the paths between transmit and receive antennas to increase data throughput and diversity. As the number of transmit and receive antennas is increased, the capacity of a MIMO channel increases linearly, and the probability of all sub-channels between the transmitter and receiver simultaneously fading decreases exponentially. As might be expected, however, there is a price associated with realization of these benefits. Recovery of transmitted information in a MIMO system becomes increasingly complex with the addition of transmit antennas. This becomes particularly true in MIMO orthogonal frequency-division multiplexing (OFDM) systems. Such systems employ a digital multi-carrier modulation scheme using numerous orthogonal sub-carriers.

Many multiple-input multiple-output (MIMO) detection algorithms have been previously proposed in the literature. The optimal algorithm is conceptually simple, but is often impractical due to the fact that its complexity increases exponentially with the number of channel inputs and alphabet size. As a result, many algorithms have been proposed to solve the problem with less complexity, with the unfortunate effect of also significantly sacrificing performance.

Many MIMO detectors have been proposed and implemented as exclusively hard detectors that only give the final estimate of the channel input. Most notable is the sphere decoding detector because it can achieve Max-Log performance in an uncoded system with much less complexity on average. A summary of many MIMO detectors may be found in D. W. Waters, “Signal Detection Strategies and Algorithms for multiple-Input Multiple-Output Channels”, Georgia Institute of Technology, PhD dissertation, December 2005, including many variations of the sphere detector that minimize complexity without sacrificing performance. At least one list-sphere detector computes the log-likelihood ratio (LLR) for a channel input. Unfortunately, implementing a list-sphere detector is still quite complex, requiring significant processing resources.

Improvements are desired to achieve a favorable performance-complexity trade-off compared to existing MIMO detectors.

### BRIEF DESCRIPTION OF THE DRAWINGS

For a detailed description of exemplary embodiments of the invention, reference will be made to the accompanying drawings in which:

FIG. 1 illustrates a block diagram of an example of a Max-Log detector, according to embodiments; and

FIG. 2 illustrates a block diagram of an exemplary communication system comprising an exemplary Max-Log detector, according to embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

It should be understood at the outset that although exemplary implementations of embodiments of the disclosure are illustrated below, embodiments may be implemented using any number of techniques, whether currently known or in existence. This disclosure should in no way be limited to the exemplary implementations, drawings, and techniques illustrated below, including the exemplary design and implementation illustrated and described herein, but may be modified within the scope of the appended claims along with their full scope of equivalents.

In light of the foregoing background, embodiments enable improved multiple-input multiple-output (MIMO) detection by providing improved Max-Log detection with low complexity. Embodiments provide novel systems and methods for multiple-input multiple-output (MIMO) Max-Log detection. These systems and methods enable near-optimal performance with low complexity for a two-input two-output channel. The only performance degradation in some embodiments is due to the Max-Log approximation, which can be compensated for by instead using, for example, a Jacobian logarithm expansion. One specific advantage of embodiments is that they do not require a QR decomposition. In fact, embodiments can be applied to a wide variety of MIMO channels, including MIMO channels created by the special precoding used in the WiMedia Alliance physical layer for the ultra wideband (UWB) system.

Although embodiments will be described for the sake of simplicity with respect to wireless communication systems, it should be appreciated that embodiments are not so limited, and can be employed in a variety of communication systems.

To better understand embodiments of this disclosure, it should be appreciated that the MIMO detection problem—namely, to recover the channel inputs given the channel outputs when there are multiple inputs and outputs—can be described using a narrowband channel model written as:

r=Hs+w, (1)

where H is an M×N matrix, s=[s₁ s₂ . . . s_{N}]^{T} is an N dimensional vector of symbols that may be drawn from different alphabets, and w is additive noise. The constellation for the i-th symbol is defined as sᵢεAᵢ. For the sake of discussion, Aᵢ will be further segmented into the sets of A_{i,R} and A_{i,I}. The set A_{i,R} is the set of unique real elements in Aᵢ, while A_{i,I} is the set of unique imaginary elements in Aᵢ. For example, if Aᵢ is a 2²ⁿ-QAM constellation, then A_{i,R} and A_{i,I} would each be a 2ⁿ-PAM constellation. QAM is the acronym for quadrature-amplitude modulation, and PAM is the acronym for pulse-amplitude modulation; for example, if n=2 then Aᵢ is a 16-QAM constellation, and A_{i,R} and A_{i,I} are each 4-PAM constellations. Similarly, it should be seen that other common alphabets 4-QAM, 16-QAM, 64-QAM, and 256-QAM correspond to n=1, 2, 3, and 4, respectively. Another common alphabet is binary phase shift keying (BPSK) where A_{i,R} contains only two values and the imaginary portion of the symbol is not used so that A_{i,I} is an empty set. Embodiments can also be readily extended to other constellations in light of the teachings of the present disclosure.

The set that contains all the elements of any one-dimensional constellation A whose j-th bit have the value k is denoted as A(k,j). For example, Aᵢ(k,j) is the set of all valid values of sᵢ whose j-th bit have the value k. Similarly, A_{i,R}(k,j) is the set of all valid values of the real part of sᵢ whose j-th bit have the value k. The set containing all valid values of the channel input vector is denoted as S, this means sεS. The set of all possible channel input vectors that have the value k in the j-th bit of the i-th element is denoted as s^{(k)}εS(k,i,j).

The optimal output of a MIMO detector is the log-likelihood ratio (LLR) of each bit transmitted in the vectors. Such LLR value indicates the probability that a given bit was transmitted as a one or zero. One way to define the LLR of the j-th bit of the i-th symbol is:

$${λ}_{i , j} = ln \frac{Pr ⌊ {b}_{i , j} = 1 \vert r ⌋}{Pr ⌊ {b}_{i , j} = 1 \vert r ⌋} , \qquad ( 2 )$$

where b_{i,j} is the j-th bit value as mapped from the channel input sᵢ. A common way to rewrite this LLR definition assumes independence among the input bits, {b_{i,j}}, and can be written as:

$$\begin{matrix}{λ}_{i , j} = ln \frac{Pr [ r \vert {b}_{i , j} = 1 ]}{Pr [ r \vert {b}_{i , j} = 0 ]} \\ = ln \frac{{\sum }_{\hat{s} ∈ S ( 1 , i , j )} Pr [ r \vert \hat{s} = s ]}{{\sum }_{\hat{s} ∈ S ( 0 , i , j )} Pr [ r \vert \hat{s} = s ]} \\ = ln {\sum }_{\hat{s} ∈ S ( 1 , i , j )} Pr [ r \vert \hat{s} = s ] - ln {\sum }_{\hat{s} ∈ S ( 0 , i , j )} Pr [ r \vert \hat{s} = s ]\end{matrix} \qquad ( 3 )$$

where ln(x) denotes the natural logarithm of x. When the noise is Gaussian, the conditional probability Pr[r|ŝ=s] can be expressed as follows:

$$Pr [ r \vert \hat{s} = s ] = \frac{1}{{( 2 π {σ}^{2} )}^{M}} exp [ - ( r - H \hat{s} ) * {( E [ ww * ] )}^{- 1} ( r - H \hat{s} ) ] . \qquad ( 4 )$$

where E[•] denotes the expectation function. As a result, it should be appreciated that the Max-Log approximation of the optimal MIMO detector output for the j-th bit of the i-th symbol is described by a single equation:

λ_{i,j}=(r−Hs^{(o)})*(E[ww*])⁻¹(r−Hs^{(o)})−(r−Hs⁽¹⁾)*(E[ww*])⁻¹(r−Hs⁽¹⁾), (5)

where s^{(k)} minimizes the cost (r−Hs^{(k)})*(E[ww*])⁻¹(r−Hs^{(k)}) under the constraint that s^{(k)}εS(k,i,j). Each embodiment implementing equation (5) is referred to as implementing a Max-Log detector because it uses the approximation that ln(e^{A}+e^{B})≈max(A,B). When the noise is white, E[ww*]=Iσ², the Max-Log detector output simplifies to:

λ_{i,j}=(∥r−Hs^{(o)}∥²−∥r−Hs⁽¹⁾∥²)/σ². (6)

It should be understood that this is only one example of how an LLR may be computed, and should not be used as a limitation on the embodiments disclosed or invention claimed. For example, it will be readily appreciated by those skilled in the art after considering the teachings of the present disclosure that a Jacobian logarithm can be used as an alternative to the Max-Log approximation by using ln(e^{A}+e^{B})≈max(A,B)+ln(1+e^{-|A-B|}) in a recursive manner. For convenience, the term Max-Log detector encompasses all such embodiments.

A modified Max-Log detector can be particularly defined in order to reduce complexity. The LLR equations in (5) and (6) do not change, but the set to which s^{(k)} belongs is further constrained. Namely, λ_{i,j} is computed according to equations (5) or (6) where s^{(k)} minimizes the cost (r−Hs^{(k)})*(E[ww*])⁻¹(r−Hs^{(k)}) under the constraint that s^{(k)}ε\tilde{S}(k,i,j). The set \tilde{S} is a subset of S so that the process of computing λ_{i,j} requires less computational complexity. In some embodiments, the set \tilde{S} is defined such that not all possible values of s₁ are included. Instead, only the values of sᵢ belonging to Ãᵢ are included in the set \tilde{S}, where Ãᵢ is a subset of Aᵢ. In the following, the discussion assumes \tilde{S}=S, but embodiments also apply to the case where \tilde{S} is further constrained. It should be appreciated that such embodiments are also referred to using the term Max-Log detector at least because they rely on the approximation ln(e^{A}+e^{B})≈max(A,B).

Embodiments of Max-Log implementation can be adapted to any bit-to-symbol mapping that maps the real and imaginary parts of at least one of the channel inputs to different bits. In other words, 0.5·log₂|Aᵢ| are mapped onto s_{i,R} and the other 0.5·log₂|Aᵢ| bits are mapped onto s_{i,I}, where sᵢ=s_{i,R}+j·s_{i,I}. The real and imaginary mappings need not be the same. Embodiments of Max-Log detection apply to various bit-to-symbol mapping examples; for example, and not by way of limitation, embodiments apply to Gray coding (see for example, IEEE Std 802.11a-1999) and dual-carrier modulation (DCM) encoding (see for example, U.S. provisional patent application Ser. No. 60/912,487 for “Dual-Carrier Modulation (DCM) Encoder-Decoder for Higher Data Rate Modes of WiMedia PHY”, hereby incorporated herein by reference).

Gray coding is defined such that the bit mapping of adjacent symbols differs in only one bit. In addition, it uses the same bit-to-symbol mapping for the real and imaginary parts of the symbol. It can be specified for an 2²ⁿ-QAM constellation by specifying the mapping for the underlying 2ⁿ-PAM constellation. For 4-PAM, the mapping may be {−3 [symbol] 00, −1 [symbol] 01, +1 [symbol] 11, +3 [symbol] 10}.

When DCM encoding is used, the two channel inputs have different bit mappings. Both channel inputs can be specified for a 16-point constellation by specifying the mapping for the underlying 4-PAM constellation. The mapping for the real part of the first input uses Gray coding {−3 [symbol] 00, −1 [symbol] 01, +1 [symbol] 11, +3 [symbol] 10}, but the mapping for the imaginary part of the first input is different {−3 [symbol] 00, −1 [symbol] 01, +1 [symbol] 10, +3 [symbol] 11}. For the second input, the mapping for the real and imaginary parts is the same {−3 [symbol] 01, −1 [symbol] 11, +1 [symbol] 00, +3 [symbol] 10}; for further discussion, please consider U.S. patent application Ser. No. 11/099,317 for “Versatile System for Dual Carrier Transformation in Orthogonal Frequency Division Multiplexing”, and U.S. provisional patent application Ser. No. 60/912,487 for “Dual-Carrier Modulation (DCM) Encoder-Decoder for Higher Data Rate Modes of WiMedia PHY”, hereby incorporated herein by reference.

In the following discussions, examples use QAM constellations that are not normalized, for example 4-QAM is used as {±1±\sqrt{−1}}. It should be understood, however that embodiments can also be applied to normalized constellations. For example, one common way to normalize the 4-QAM constellation is to divide each element by \sqrt{2}, i.e. {±1/\sqrt{2}±\sqrt{1}/\sqrt{2}}.

Initially, the cost of an arbitrary vector ŝ can be written as:

C(ŝ)=(r−Hŝ)*W(r−Hŝ), (7)

where W=(E[ww*])⁻¹. Of particular interest is the case where W is a diagonal matrix. For a two-dimensional channel, the cost of ŝ is explicitly written as:

$$C ( {\hat{s}}_{1} , {\hat{s}}_{2} ) = ( [ \begin{matrix}{r}_{1} \\ {r}_{2}\end{matrix} ] - [ \begin{matrix}{h}_{1 , 1} & {h}_{1 , 2} \\ {h}_{2 , 1} & {h}_{2 , 2}\end{matrix} ] [ \begin{matrix}{\hat{s}}_{1} \\ {\hat{s}}_{2}\end{matrix} ] ) * [ \begin{matrix}{w}_{1 , 1} & 0 \\ 0 & {w}_{2 , 2}\end{matrix} ] ( [ \begin{matrix}{r}_{1} \\ {r}_{2}\end{matrix} ] - [ \begin{matrix}{h}_{1 , 1} & {h}_{1 , 2} \\ {h}_{2 , 1} & {h}_{2 , 2}\end{matrix} ] [ \begin{matrix}{\hat{s}}_{1} \\ {\hat{s}}_{2}\end{matrix} ] ) . \qquad ( 8 )$$

The LLR value for the j-th bit of the i-th symbol is computed from the cost as follows:

$${λ}_{i , j} = \{ \begin{matrix}{min}_{{\hat{s}}_{1} ∈ {A}_{1} ( 0 , j ) , {\hat{s}}_{2} ∈ {A}_{2}} C ( {\hat{s}}_{1} , {\hat{s}}_{2} ) - {min}_{{\hat{s}}_{1} ∈ {A}_{1} ( 1 , j ) , {\hat{s}}_{2} ∈ {A}_{2}} C ( {\hat{s}}_{1} , {\hat{s}}_{2} ) & if i = 1 \\ {min}_{{\hat{s}}_{1} ∈ {A}_{1} , {\hat{s}}_{2} ∈ {A}_{2} ( 0 , j )} C ( {\hat{s}}_{1} , {\hat{s}}_{2} ) - {min}_{{\hat{s}}_{1} ∈ {A}_{1} , {\hat{s}}_{2} ∈ {A}_{2} ( 1 , j )} C ( {\hat{s}}_{1} , {\hat{s}}_{2} ) & if i = 2\end{matrix} \qquad ( 9 )$$

Again, the modified Max-Log detector can be specially defined to reduce complexity:

$${λ}_{i , j} = \{ \begin{matrix}{min}_{{\hat{s}}_{1} ∈ {\tilde{A}}_{1} ( 0 , j ) , {\hat{s}}_{2} ∈ {A}_{2}} C ( {\hat{s}}_{1} , {\hat{s}}_{2} ) - {min}_{{\hat{s}}_{1} ∈ {\tilde{A}}_{1} ( 1 , j ) , {\hat{s}}_{2} ∈ {A}_{2}} C ( {\hat{s}}_{1} , {\hat{s}}_{2} ) & if i = 1 \\ {min}_{{\hat{s}}_{1} ∈ {\tilde{A}}_{1} , {\hat{s}}_{2} ∈ {A}_{2} ( 0 , j )} C ( {\hat{s}}_{1} , {\hat{s}}_{2} ) - {min}_{{\hat{s}}_{1} ∈ {\tilde{A}}_{1} , {\hat{s}}_{2} ∈ {A}_{2} ( 1 , j )} C ( {\hat{s}}_{1} , {\hat{s}}_{2} ) & if i = 2.\end{matrix}$$

The set Ã₁ here can be any subset of Ã₁ that is preferably chosen in a way to minimize performance loss of the modified Max-Log detector relative to the Max-Log detector.

It should be appreciated that computing the set of LLR values requires minimizing the cost function twice for each bit in each symbol. However, the set over which it is minimized is different in each case. Many symbol-to-bit mappings independently map bits onto the real and imaginary portions of the symbols. Such mappings can be exploited to simplify minimizing the cost function. Specifically, the simplified cost function can be written in the following form:

C(\tilde{s}₁,\tilde{s}₂)=α(\tilde{s}₁)+C_{R}(\tilde{s}₁,\tilde{s}_{2,R})+C_{I}(\tilde{s}₁,\tilde{s}_{2,I}), (10)

where \tilde{s}ᵢ=\tilde{s}_{i,R}+\sqrt{−1}·\tilde{s}_{i,I}, and α(\tilde{s}₁) is independent of \tilde{s}₂. Different ways to compute α(\tilde{s}₁), C_{R}(\tilde{s}₁,\tilde{s}_{2,R}), and C_{I}(\tilde{s}₁,\tilde{s}_{2,I}) will be described later. For convenience, these values will be referred to herein as the first layer cost α(\tilde{s}₁), the second layer real cost C_{R}(\tilde{s}₁,\tilde{s}_{2,R}), and the second layer imaginary cost C_{I}(\tilde{s}₁,\tilde{s}_{2,I}). Equation (10) is preferably used to implement embodiments of Max-Log detection.

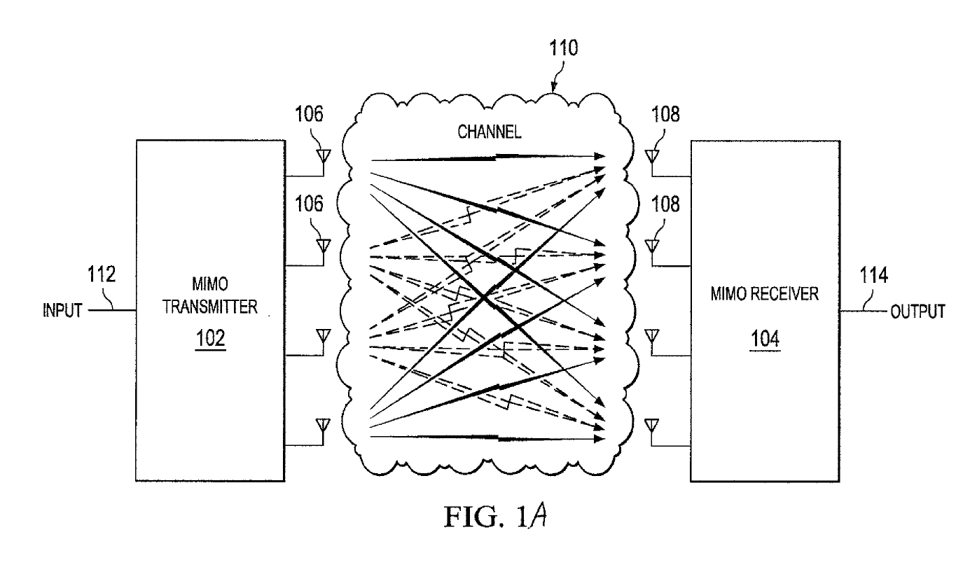

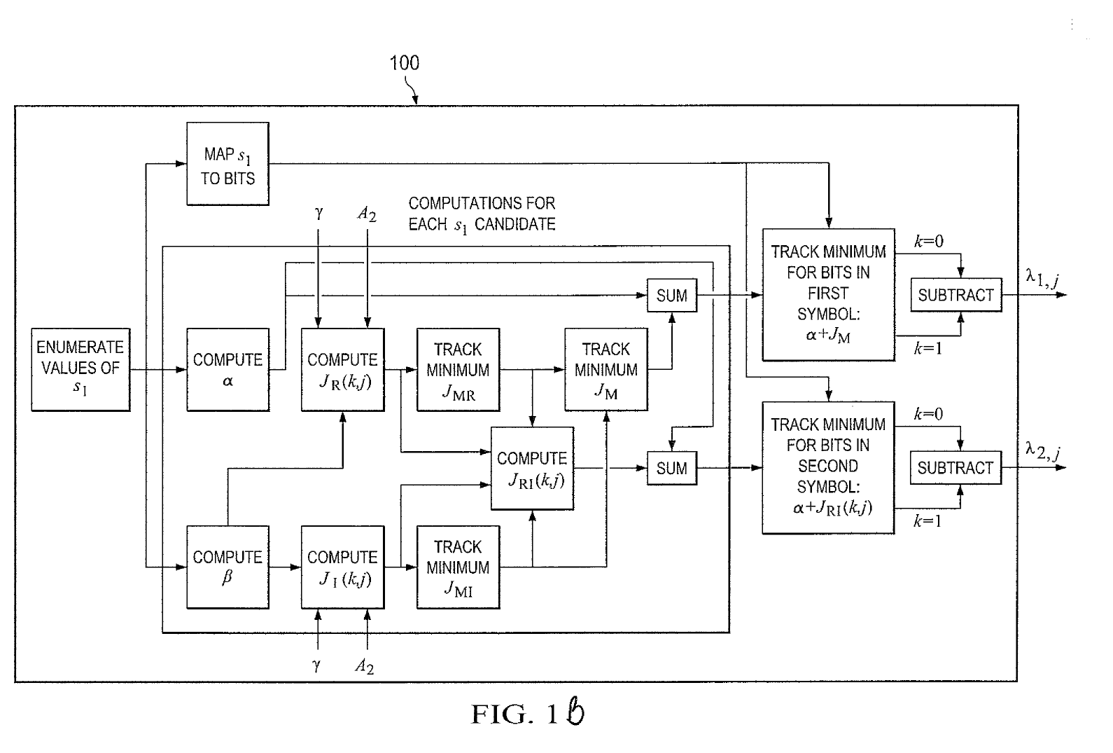

FIG. 1A shows an illustrative embodiment of a MIMO system in accordance with embodiments of the invention. MIMO transmitter 102 includes one or more antennas 106 for transmitting radio frequency signals. MIMO transmitter 102 may, in general, be a fixed or portable wireless device, a cellular phone, a personal digital assistant, a wireless modem card, or any other device configured to transmit on a MIMO wireless network. MIMO receiver 104 is configured to receive radio frequency signals transmitted by MIMO transmitter 102. MIMO receiver 104 includes one or more antennas 108 for receiving transmitted radio frequency signals.

MIMO transmitter 102 transmits radio frequency signals to MIMO receiver 104 through channel 110. While MIMO systems may greatly increase spectral efficiency, the process of separating signals simultaneously transmitted from multiple antennas 106 may be burdensome for receiver 104. For a symbol constellation of size A and a MIMO transmitter 102 including N transmit antennas, the brute-force implementation of the ML detector must compute A^{N} distances between the received signal vector and each of the A^{N} candidates for the transmitted signal vector. Thus while providing optimal performance, the computational burden may make implementation of the ML detector impractical for MIMO receiver 104. To reduce the detector's computational complexity, the MIMO receiver 104 preferably includes a detector structure based on the CLIC framework. For example, the complexity of an ML detector implementation may be reduced by employing the CLIC framework as described below to break the detection problem into two parts.

FIG. 1B illustrates a block diagram of an exemplary Max-Log detector, according to embodiments, for computing LLR values. Specifically, computation of the LLR values for each bit in the symbol will now be described. Assume that the first 0.5·log₂|Aᵢ| bits in sᵢ=s_{i,R}+\sqrt{−1}·s_{i,I} are mapped onto s_{i,R}, and the last 0.5·log₂|Aᵢ| bits in sᵢ are mapped onto s_{i,I} as would be the case in Gray coding. It should, of course, be appreciated that any mapping will work as long as the bits are independently mapped onto s_{i,R} and s_{i,I}. This means that C_{R}(ŝ₁,ŝ_{2,R}) and C_{I}(ŝ₁,ŝ_{2,I}) as described in equation (10) can be independently minimized in order to compute the LLR values according to equation (9). Namely, for each possible value of s₁ the following 2·log₂|A₂| minimums are computed (j=1 . . . log₂|A₂|):

J_{R}(ŝ₁,k,j)=min_{ŝ}_{_{2,R}}_{εA}_{_{2,R}}_{(k,j)}C_{R}(ŝ₁,ŝ_{2,R}), j≦0.5·log₂|A₂| (11)

J_{I}(ŝ₁,k,j)=min_{ŝ}_{_{2,I}}_{εA}_{_{2,I}}_{(k,j-0.5·log}_{₂}_{|A}_{₂}_{|)}C_{I}(ŝ₁,ŝ_{2,I}), j>0.5·log₂|A₂|. (12)

For convenience the two minimums J_{R}(ŝ₁,k,j) and J_{I}(ŝ₁,k,j) are referred to as the real and imaginary kernels, respectively, because they are important to the Max-Log detector computations. As the values of s₁ are enumerated, both J_{R}(ŝ₁,k,j) and J_{I}(ŝ₁,k,j) are computed so that the following minimums can also be computed:
The partial minimum of the imaginary part of the second symbol:

J_{MI}(ŝ₁)=min_{k=0,1,j>0.5·log}_{₂}_{|A}_{₂}_{|}J_{I}(ŝ₁,k,j) (13)

The partial minimum of the real part of the second symbol:

J_{MR}(ŝ₁)=min_{k=0,1,j≦0.5·log}_{₂}_{|A}_{₂}_{|}J_{R}(ŝ₁,k,j) (14)

The local minimum for the first symbol:

J_{M}(ŝ₁)=J_{MR}(ŝ₁)+J_{MI}(ŝ₁) (15)

The bit-level local minimums for the first symbol:

$${J}_{RI} ( {\hat{s}}_{1} , k , j ) = \{ \begin{matrix}{J}_{R} ( {\hat{s}}_{1} , k , j ) + {J}_{MI} ( {\hat{s}}_{1} ) & if j \leq 0.5 \cdot {log}_{2} \vert {A}_{2} \vert \\ {J}_{MR} ( {\hat{s}}_{1} ) + {J}_{I} ( {\hat{s}}_{1} , k , j ) & if j > 0.5 \cdot {log}_{2} \vert {A}_{2} \vert\end{matrix} \qquad ( 16 )$$

The LLR values in equation (9) (i=1, 2, j=1 . . . log₂|A₂|) are then computed as:

$${λ}_{i , j} = \{ \begin{matrix}\begin{matrix}{min}_{{\hat{s}}_{1} ∈ {A}_{1} ( 0 , j )} ( α ( {\hat{s}}_{1} ) + {J}_{M} ( {\hat{s}}_{1} ) ) - \\ {min}_{{\hat{s}}_{1} ∈ {A}_{1} ( 1 , j )} ( α ( {\hat{s}}_{1} ) + {J}_{M} ( {\hat{s}}_{1} ) )\end{matrix} & if i = 1 \\ \begin{matrix}{min}_{{\hat{s}}_{1} ∈ {A}_{1}} ( α ( {\hat{s}}_{1} ) + {J}_{RI} ( {\hat{s}}_{1} , 0 , j ) ) - \\ {min}_{{\hat{s}}_{1} ∈ {A}_{1}} ( α ( {\hat{s}}_{1} ) + {J}_{RI} ( {\hat{s}}_{1} , 1 , j ) )\end{matrix} & if i = 2\end{matrix} \qquad ( 17 )$$

In summary, the set of LLR values are computed according to equation (17) which may be implemented by computing α(ŝ₁), J_{RI}(ŝ₁,k,j) and J_{M}(ŝ₁) for each value of ŝ₁, i.e. ŝ₁εA₁ or ŝ₁εÃ₁ for a modified Max-Log detector, and keeping track of the minimum values for each j and k. Note that the roles of s₁ and s₂ could be reversed without changing the resulting LLR value; in other words s₂ could be enumerated instead of s₁. A first step towards computing J_{RI}(ŝ₁,k,j) and J_{M}(ŝ₁) is to compute the values J_{R}(ŝ₁,k,j) and J_{I}(ŝ₁,k,j) for each k and each j.

Embodiments enable computation of J_{R}(ŝ₁,k,j) and J_{I}(ŝ₁,k,j) to be performed in series, in parallel, or a mixture of the two as desired. A serial implementation may compute J_{R}(ŝ₁,k,j) by computing C_{R}(ŝ₁,ŝ_{2,R}) for each value of ŝ₁ and comparing the most recent cost to the costs or smallest cost already computed. Alternatively, the elements in A₁ could be divided into groups, then the minimum C_{R}(ŝ₁,ŝ_{2,R}) from each group are computed, and then the minimum from the set of minimums is determined.

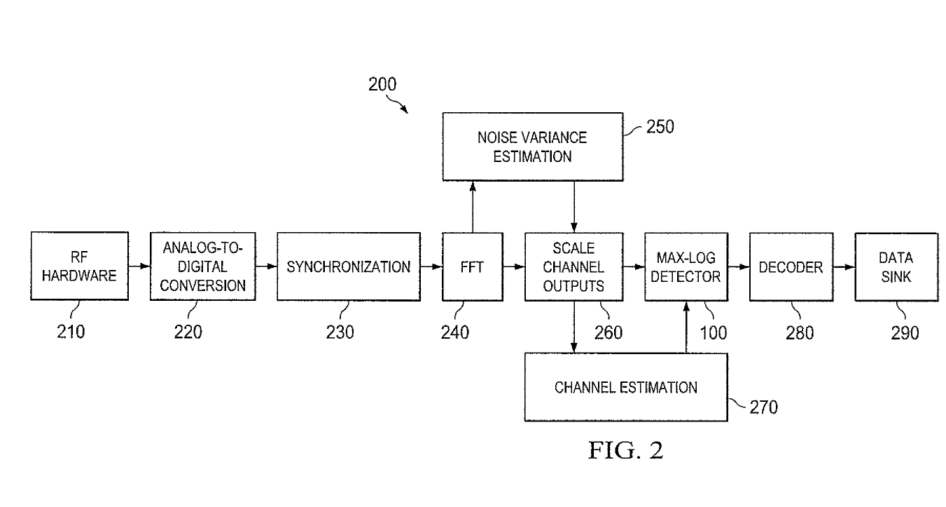

FIG. 2 is a block diagram of an exemplary communication system 200 in which embodiments of MIMO Max-Log detector 100 may be used to advantage. Specifically, a wireless (e.g., radio frequency) stream of information is received at RF hardware 210, converted to a digital stream at analog-to-digital converter 220, and synchronized at 230. At this point the start of the packet has been located, and the digital stream is passed through a fast-Fourier transformation at FFT 240. The output of FFT 240 is provided to estimator 250 which estimates the noise variance of the stream. The outputs of FFT 240 and estimator 250 are provided to scaler 260 where the channel stream is preferably scaled using the noise variance estimation on the transformed stream, and separated into components. For an example, and not by way of limitation, of a scaler 260, reference is made to “Scaling to Reduce Wireless Signal Detection Complexity”, U.S. patent application Ser. No. 11/928,050, filed Oct. 30, 2007, hereby incorporated in its entirety herein by reference. The outputs of scaler 260 are preferably fed to channel estimator 270 which estimates the H matrix. Scaler 260 forwards channel output, r, and channel estimator 270 forwards the estimated H matrix to MIMO detector 100. MIMO detector 100, which will be described as comprising a Max-Log or modified Max-Log detector for portions of this discussion, generates LLR values which are in turn provided to decoder 280 for analysis and/or further processing. The output of decoder 280 is stored in data sink 290 which can be any form of memory now known or later developed.

How to compute the LLR values representing cost will now be derived. Expansion of equation (8) yields:

$$\begin{matrix}C ( {\hat{s}}_{1} , {\hat{s}}_{2} ) = ( [ \begin{matrix}{r}_{1} - {h}_{1 , 1} {\hat{s}}_{1} - {h}_{1 , 2} {\hat{s}}_{2} \\ {r}_{2} - {h}_{2 , 1} {\hat{s}}_{1} - {h}_{2 , 2} {\hat{s}}_{2}\end{matrix} ] ) * [ \begin{matrix}{w}_{1 , 1} & 0 \\ 0 & {w}_{2 , 2}\end{matrix} ] ( [ \begin{matrix}{r}_{1} - {h}_{1 , 1} {\hat{s}}_{1} - {h}_{1 , 2} {\hat{s}}_{2} \\ {r}_{2} - {h}_{2 , 1} {\hat{s}}_{1} - {h}_{2 , 2} {\hat{s}}_{2}\end{matrix} ] ) \\ = ( [ \begin{matrix}{r}_{1} - {h}_{1 , 1} {\hat{s}}_{1} - {h}_{1 , 2} {\hat{s}}_{2} \\ {r}_{2} - {h}_{2 , 1} {\hat{s}}_{1} - {h}_{2 , 2} {\hat{s}}_{2}\end{matrix} ] ) * [ \begin{matrix}{w}_{1 , 1} & 0 \\ 0 & {w}_{2 , 2}\end{matrix} ] ( [ \begin{matrix}{r}_{1} - {h}_{1 , 1} {\hat{s}}_{1} - {h}_{1 , 2} {\hat{s}}_{2} \\ {r}_{2} - {h}_{2 , 1} {\hat{s}}_{1} - {h}_{2 , 2} {\hat{s}}_{2}\end{matrix} ] ) \\ = {w}_{1 , 1} {\vert {r}_{1} - {h}_{1 , 1} {\hat{s}}_{1} - {h}_{1 , 2} {\hat{s}}_{2} \vert}^{2} + {w}_{2 , 2} {\vert {r}_{2} - {h}_{2 , 1} {\hat{s}}_{1} - {h}_{2 , 2} {\hat{s}}_{2} \vert}^{2} .\end{matrix} \qquad ( 18 )$$

For convenience, yᵢ(ŝ₁)=rᵢ−h_{i,1}ŝ₁ is substituted to achieve:

C(ŝ₁,ŝ₂)=w_{1,1}|y₁(ŝ₁)−h_{1,2}ŝ₂|²+w_{2,2}|y₂(ŝ₁)−h_{2,2}ŝ₂|². (19)

The squared terms expand to obtain the following:

$$\begin{matrix}C ( {\hat{s}}_{1} , {\hat{s}}_{2} ) = {w}_{1 , 1} ( {\vert {y}_{1} ( {\hat{s}}_{1} ) \vert}^{2} - 2 Re ( {y}_{1}^{*} ( {\hat{s}}_{1} ) {h}_{1 , 2} {\hat{s}}_{2} ) + {\vert {h}_{1 , 2} {\hat{s}}_{2} \vert}^{2} ) + \\ {w}_{2 , 2} ( {\vert {y}_{2} ( {\hat{s}}_{1} ) \vert}^{2} - 2 Re ( {y}_{2}^{*} ( {\hat{s}}_{1} ) {h}_{2 , 2} {\hat{s}}_{2} ) + {\vert {h}_{2 , 2} {\hat{s}}_{2} \vert}^{2} ) \\ = ( {w}_{1 , 1} {\vert {y}_{1} ( {\hat{s}}_{1} ) \vert}^{2} + {w}_{2 , 2} {\vert {y}_{2} ( {\hat{s}}_{1} ) \vert}^{2} ) - \\ Re ( 2 {\hat{s}}_{2} ( {y}_{1}^{*} ( {\hat{s}}_{1} ) {h}_{1 , 2} {w}_{1 , 1} + {y}_{2}^{*} ( {\hat{s}}_{1} ) {h}_{2 , 2} {w}_{2 , 2} ) ) + \\ {\vert {\hat{s}}_{2} \vert}^{2} ( {\vert {h}_{1 , 2} \vert}^{2} + {\vert {h}_{2 , 2} \vert}^{2} ) \\ = ρ ( {\hat{s}}_{1} ) - 2 Re ( {β }^{*} ( {\hat{s}}_{1} ) \cdot {\hat{s}}_{2} ) + {\vert {\hat{s}}_{2} \vert}^{2} γ\end{matrix} \qquad ( 20 )$$

The following variables are introduced to make the notation more concise:

β*(ŝ₁)=β_{R}(ŝ₁)−j·β₁(s₁=y*₁(ŝ₁)h_{1,2}w_{1,1}+y*₂(ŝ₁)h_{2,2}w_{2,2}

γ=w_{1,1}|h_{1,2}|²+w_{2,2}|h_{2,2}|²

ρ(ŝ₁)=w_{1,1}|y₁(ŝ₁)|²+w_{2,2}|y₂(ŝ₁)|². (21)

These three variables—β, γ, and β—are fundamental to implementation of embodiments of Max-Log detection 100. For convenience, the variable β may be referred to in the present discussion as the cross-product, the γ referred to as the norm, and ρ(ŝ₁) referred to as the local norm. Once these three variables are computed, then the minimizations of equations (11) and (12) may be found.

Some embodiments directly compute J_{R}(ŝ₁,k,j) and J_{I}(ŝ₁,k,j); other embodiments compute J_{R}(ŝ₁,k,j) and J_{I}(ŝ₁,k,j) by using a look-up table (LUT). It will be appreciated that each type of embodiment defines α(ŝ₁), C_{R}(ŝ₁,ŝ_{2,R}), and C_{I}(ŝ₁,ŝ_{2,I}) differently as explained below.

Consider first embodiments which directly compute J_{R}(ŝ₁,k,j) and J_{I}(ŝ₁,k,j). The three terms from the right-hand side of equation (10) can be rewritten in terms of the new variables from equation (21) as follows:

α(ŝ₁)=ρ(ŝ₁), (22)

C_{R}(ŝ₁,ŝ_{2,R})=ŝ_{2,R}²γ−2β_{R}(ŝ₁)ŝ_{2,R} (23)

C_{I}(ŝ₁,ŝ_{2,I})=ŝ_{2,I}²γ−2β_{I}(ŝ₁)ŝ_{2,I}. (24)

There are multiple ways to implement embodiments based on direct computation. For example, and not by way of limitation, embodiments may implement what shall be referred to herein as brute-force direct computation (BF-DC), rule-based direct computation (R-DC), and/or slicer-based direct computation (S-DC). In embodiments implementing BF-DC, assuming that γ, β_{I}(ŝ₁) and β_{R}(ŝ₁) have already been computed, then J_{R}(ŝ₁,k,j) and J_{I}(ŝ₁,k,j) can be computed by minimizing C_{R}(ŝ₁,ŝ_{2,R}) and C_{I}(ŝ₁,ŝ_{2,I}) per equations (11) and (12). It is considered brute-force because embodiments implementing BF-DC compute all instances of the cost functions.

Alternatively, embodiments implementing R-DC for computing the minimizations J_{R}(ŝ₁,k,j) and J_{I}(ŝ₁,k,j) do so by computing only one value of C_{R}(ŝ₁,ŝ_{2,R}) or C_{I}(ŝ₁,ŝ_{2,I}). Deciding which value of ŝ_{2,R} and ŝ_{2,I} for which to compute C_{R}(ŝ₁,ŝ_{2,R}) and C_{I}(ŝ₁,ŝ_{2,I}), respectively, can be done by computing γ, β_{R}(ŝ₁) and β₁(ŝ₁) then applying the rules as specified in the following tables depending on the alphabet to which s₂ belongs. Each alphabet and each different symbol-to-bit mapping employs a different set of rules. The following tables are designed for a Gray-coded mapping, but the concept can be easily adapted to any symbol-to-bit mapping in view of the teachings of the present disclosure.

4-QAM. Although implementing the minimizations for 4-QAM is trivial because there is only one possibility for each bit taking on a certain value, it is included for the sake of understanding and thoroughness.

TABLE 1
Minimization rules for 4-QAM.

J_{R}(ŝ₁, 0, 1) = C_{R}(ŝ₁, −1)
J_{R}(ŝ₁, 1, 1) = C_{R}(ŝ₁, 1)
J_{I}(ŝ₁, 0, 2) = C_{I}(ŝ₁, −1)
J_{I}(ŝ₁, 1, 2) = C_{I}(ŝ₁, 1)

16-QAM. Assume that A₂ is the 16-QAM alphabet, and it has a Gray-coded bit-to-symbol mapping. This means that there are eight different required minimizations (two for each bit), and embodiments implementing BF-DC compute eight cost functions. The eight minimizations associated with the real part of the symbol are enumerated in Table 2. Note that the two most significant bits (MSB) map to s_{2,R}, while the two least significant bits map to s_{2,I}. The following is one example of minimization; the other embodiments can be similarly derived. Further, similar rules can be derived for other bit-to-symbol mappings.

Consider the case when the MSB is zero (j=1, k=0); this implies that ŝ_{2,R} is either −1 or −3. Embodiments compute the minimum cost of these two possibilities, which is J_{R}(ŝ₁,0,1)=min{C_{R}(ŝ₁,−1), C_{R}(ŝ₁,−3)} according to the above notation. Equations (23) and (24) derive C_{R}(ŝ₁,−1)=2β_{R}(ŝ₁)+γ and C_{R}(ŝ₁,−3)=6β_{R}(ŝ₁)+9γ, respectively. Thus, equation (11) is equivalent to J_{R}(ŝ₁,0,1)=min{2β_{R}(ŝ₁)±γ,6β_{R}(ŝ₁)+9γ}. A simple rule tells which of these two is smaller; namely, if β_{R}(ŝ₁)>−2γ, then C_{R}(ŝ₁,−1)<C_{R}(ŝ₁,−3). The minimization is then computed according to:

$${J}_{R} ( {\hat{s}}_{1} , 0 , 1 ) = \{ \begin{matrix}{C}_{R} ( {\hat{s}}_{1} , - 1 ) & if {β}_{R} ( {\hat{s}}_{1} ) > - 2 γ \\ {C}_{R} ( {\hat{s}}_{1} , - 3 ) & else .\end{matrix} \qquad ( 25 )$$

Using this rule, the minimum of C_{R}(ŝ₁,−1) and C_{R}(ŝ₁,−3) can be computed without explicitly computing both values. The rules for the other bits are given in Table 2. In the tables, only the rules for the bits mapped onto the real part of the symbol are given. However, due to the Gray coding structure the rules for the bits mapped onto the imaginary part are obtained by replacing β_{R}(ŝ₁) with −β_{I}(ŝ₁) in the rules table.

TABLE 2
Minimization rules for Gray-coded 16-QAM.
${J}_{R} ( {\hat{s}}_{1} , 0 , 1 ) = \{ \begin{matrix}{C}_{R} ( {\hat{s}}_{1} , - 1 ) & if & {β}_{R} ( {\hat{s}}_{1} ) > - 2 γ \\ {C}_{R} ( {\hat{s}}_{1} , - 3 ) & else & \end{matrix}$
${J}_{R} ( {\hat{s}}_{1} , 1 , 1 ) = \{ \begin{matrix}{C}_{R} ( {\hat{s}}_{1} , 1 ) & if & {β}_{R} ( {\hat{s}}_{1} ) < 2 γ \\ {C}_{R} ( {\hat{s}}_{1} , 3 ) & else & \end{matrix}$
${J}_{R} ( {\hat{s}}_{1} , 0 , 2 ) = \{ \begin{matrix}{C}_{R} ( {\hat{s}}_{1} , - 3 ) & if & {β}_{R} ( {\hat{s}}_{1} ) < 0 \\ {C}_{R} ( {\hat{s}}_{1} , 3 ) & else & \end{matrix}$
${J}_{R} ( {\hat{s}}_{1} , 1 , 2 ) = \{ \begin{matrix}{C}_{R} ( {\hat{s}}_{1} , - 1 ) & if & {β}_{R} ( {\hat{s}}_{1} ) < 0 \\ {C}_{R} ( {\hat{s}}_{1} , 1 ) & else & \end{matrix}$

64-QAM. Assume that A₂ is the 64-QAM alphabet, and it has a Gray-coded bit-to-symbol mapping. This means that there are 12 different required minimizations (two for each bit). The R-DC implementation rules for the six minimizations associated with the real part of the symbol are shown in Table 3; it should be readily appreciated that rules for the minimizations associated with the imaginary part are similar. It should be noted that the rules set forth in Table 3 are based on the assumption that the three most significant bits (MSB) map to s_{2,R}, while the three least significant bits map to s_{2,I}. Embodiments which implement BF-DC compute 16 cost functions (8 values for the real symbols and 8 values for the imaginary symbols), then the minimum of the 16 costs (or cost functions) is determined for each value of each bit. Embodiments which implement R-DC are less complex than embodiments which implement BF-DC in the 64-QAM case, because by following the rules at most 12 cost functions are computed and more importantly which of the cost functions is smallest (the minimum) for each value of each bit directly follows from the rules.

TABLE 3
Minimization rules for Gray coded 64-QAM.
${J}_{R} ( {\hat{s}}_{1} , 0 , 1 ) = \{ \begin{matrix}{C}_{R} ( {\hat{s}}_{1} , - 7 ) & if & {β}_{R} ( {\hat{s}}_{1} ) < - 6 γ \\ {C}_{R} ( {\hat{s}}_{1} , - 5 ) & if & - 4 γ > {β}_{R} ( {\hat{s}}_{1} ) ≧ - 6 γ \\ {C}_{R} ( {\hat{s}}_{1} , - 3 ) & if & - 2 γ > {β}_{R} ( {\hat{s}}_{1} ) ≧ - 4 γ \\ {C}_{R} ( {\hat{s}}_{1} , - 1 ) & else & {β}_{R} ( {\hat{s}}_{1} ) ≧ - 2 γ\end{matrix}$
${J}_{R} ( {\hat{s}}_{1} , 1 , 1 ) = \{ \begin{matrix}{C}_{R} ( {\hat{s}}_{1} , 7 ) & if & {β}_{R} ( {\hat{s}}_{1} ) > 6 γ \\ {C}_{R} ( {\hat{s}}_{1} , 5 ) & if & 4 γ < {β}_{R} ( {\hat{s}}_{1} ) ≦ 6 γ \\ {C}_{R} ( {\hat{s}}_{1} , 3 ) & if & 2 γ < {β}_{R} ( {\hat{s}}_{1} ) ≦ 4 γ \\ {C}_{R} ( {\hat{s}}_{1} , 1 ) & else & {β}_{R} ( {\hat{s}}_{1} ) ≦ 2 γ\end{matrix}$
${J}_{R} ( {\hat{s}}_{1} , 0 , 2 ) = \{ \begin{matrix}{C}_{R} ( {\hat{s}}_{1} , - 7 ) & if & {β}_{R} ( {\hat{s}}_{1} ) < - 6 γ \\ {C}_{R} ( {\hat{s}}_{1} , - 5 ) & if & 0 > {β}_{R} ( {\hat{s}}_{1} ) ≧ - 6 γ \\ {C}_{R} ( {\hat{s}}_{1} , 5 ) & if & 6 γ > {β}_{R} ( {\hat{s}}_{1} ) ≧ 0 \\ {C}_{R} ( {\hat{s}}_{1} , 7 ) & else & {β}_{R} ( {\hat{s}}_{1} ) ≧ 6 γ\end{matrix}$
${J}_{R} ( {\hat{s}}_{1} , 1 , 2 ) = \{ \begin{matrix}{C}_{R} ( {\hat{s}}_{1} , - 3 ) & if & {β}_{R} ( {\hat{s}}_{1} ) < - 2 γ \\ {C}_{R} ( {\hat{s}}_{1} , - 1 ) & if & 0 > {β}_{R} ( {\hat{s}}_{1} ) ≧ - 2 γ \\ {C}_{R} ( {\hat{s}}_{1} , 1 ) & if & 2 γ > {β}_{R} ( {\hat{s}}_{1} ) ≧ 0 \\ {C}_{R} ( {\hat{s}}_{1} , 3 ) & else & {β}_{R} ( {\hat{s}}_{1} ) ≧ 2 γ\end{matrix}$
${J}_{R} ( {\hat{s}}_{1} , 0 , 3 ) = \{ \begin{matrix}{C}_{R} ( {\hat{s}}_{1} , - 7 ) & if & {β}_{R} ( {\hat{s}}_{1} ) < - 4 γ \\ {C}_{R} ( {\hat{s}}_{1} , - 1 ) & if & 0 > {β}_{R} ( {\hat{s}}_{1} ) ≧ - 4 γ \\ {C}_{R} ( {\hat{s}}_{1} , 1 ) & if & 4 γ > {β}_{R} ( {\hat{s}}_{1} ) ≧ 0 \\ {C}_{R} ( {\hat{s}}_{1} , 7 ) & else & {β}_{R} ( {\hat{s}}_{1} ) ≧ 4 γ\end{matrix}$
${J}_{R} ( {\hat{s}}_{1} , 1 , 3 ) = \{ \begin{matrix}{C}_{R} ( {\hat{s}}_{1} , - 5 ) & if & {β}_{R} ( {\hat{s}}_{1} ) < - 4 γ \\ {C}_{R} ( {\hat{s}}_{1} , - 3 ) & if & 0 > {β}_{R} ( {\hat{s}}_{1} ) ≧ - 4 γ \\ {C}_{R} ( {\hat{s}}_{1} , 3 ) & if & 4 γ > {β}_{R} ( {\hat{s}}_{1} ) ≧ 0 \\ {C}_{R} ( {\hat{s}}_{1} , 5 ) & else & {β}_{R} ( {\hat{s}}_{1} ) ≧ 4 γ\end{matrix}$

The third type of embodiments for directly computing J_{R}(ŝ₁,k,j) is S-DC which computes the symbol ŝ_{2,R} that minimizes C_{R}(ŝ₁,ŝ_{2,R}) using a slicer. Similarly, J_{I}(ŝ₁,k,j) is directly computed by computing the symbol ŝ_{2,I} that minimizes C_{I}(ŝ₁,ŝ_{2,I}) using a slicer. A slicer is defined as follows:

slicer(x,A)=arg min_{ŝεA}|ŝ−x|². (26)

It can be seen that equation (11) can be computed applying the slicer as follows:

$${J}_{R} ( {\hat{s}}_{1} , k , j ) = {C}_{R} ( {\hat{s}}_{1} , slicer ( \frac{{β}_{R} ( {\hat{s}}_{1} )}{γ} , {A}_{2 , R} ) ) . \qquad ( 27 )$$

Similarly, equation (12) can be computed as follows:

$${J}_{R} ( {\hat{s}}_{1} , k , j ) = {C}_{I} ( {\hat{s}}_{1} , slicer ( \frac{{β}_{I} ( {\hat{s}}_{1} )}{γ} , {A}_{2 , I} ) ) . \qquad ( 28 )$$

Note that the rules in Tables 1, 2, and 3 yield the same results as equations (27) and (28), and may therefore be considered special cases of embodiments implementing S-DC that reduce complexity by avoiding computing β_{R}(ŝ₁)/γ and β_{I}(ŝ₁)/γ. It should be appreciated that embodiments employing a slicer such as defined here will also work for any other alphabet not shown in the tables.

Consider now embodiments which employ a look-up table (LUT) to compute J_{R}(ŝ₁,k,j) and J_{I}(ŝ₁,k,j). An alternative form of equation (20) rearranges the terms so that the cost can be computed using a set of look-up tables. The square is completed to arrive at an equivalent form of the cost equation:

$$C ( {\hat{s}}_{1} , {\hat{s}}_{2} ) = ρ ( {\hat{s}}_{1} ) - \frac{{\vert β ( {\hat{s}}_{1} ) \vert}^{2}}{γ} + γ {\vert {\hat{s}}_{2} - \frac{β ( {\hat{s}}_{1} )}{γ} \vert}^{2} . \qquad ( 29 )$$

Next, dependencies on the real and imaginary components of ŝ₂ are separated:

$$C ( {\hat{s}}_{1} , {\hat{s}}_{2} ) = ρ ( {\hat{s}}_{1} ) - \frac{{\vert β ( {\hat{s}}_{1} ) \vert}^{2}}{γ} + γ {\vert {\hat{s}}_{2 , R} - \frac{{β}_{R} ( {\hat{s}}_{1} )}{γ} \vert}^{2} + γ {\vert {\hat{s}}_{2 , I} - \frac{{β}_{I} ( {\hat{s}}_{1} )}{γ} \vert}^{2} . \qquad ( 30 )$$

The three terms in equation (10) can be rewritten in terms of the new variables as follows:

$$\begin{matrix}α ( {\hat{s}}_{1} ) = ρ ( {\hat{s}}_{1} ) - \frac{{\vert β ( {\hat{s}}_{1} ) \vert}^{2}}{γ} , & ( 31 ) \\ {C}_{R} ( {\hat{s}}_{1} , {\hat{s}}_{2 , R} ) = γ {\vert {\hat{s}}_{2 , R} - \frac{{β}_{R} ( {\hat{s}}_{1} )}{γ} \vert}^{2} , & ( 32 ) \\ {C}_{I} ( {\hat{s}}_{1} , {\hat{s}}_{2 , I} ) = γ {\vert {\hat{s}}_{2 , I} - \frac{{β}_{I} ( {\hat{s}}_{1} )}{γ} \vert}^{2} . & ( 33 )\end{matrix}$$

Now equations (11) and (12) can be computed using one-dimensional look-up tables because of the form of equations (32) and (33). Embodiments of the LUT are preferably defined as follows:

LUT_{R}(x,k,j)=min_{ŝεA}_{_{2,R}}_{(k,j)}|ŝ−x|² (34)

LUT_{I}(x,k,j)=min_{ŝεA}_{_{2,I}}_{(k,j)}|s−x|² (35)

These look-up table (LUT) definitions apply to any bit-mapping where the real and imaginary parts of a symbol are independently mapped to bit values. As mentioned earlier, two such examples are Gray coding, and DCM encoding. Gray coding has the additional benefit that A_{2,R}=A_{2,I} so that the look-up tables are the same LUT_{R}(x,k,j)=LUT_{I}(x,k,j). Equations (11) and (12) are computed as:

$$\begin{matrix}{J}_{R} ( {\hat{s}}_{1} , k , j ) = γ \cdot {LUT}_{R} ( \frac{{β}_{R} ( {\hat{s}}_{1} )}{γ} , k , j ) , j \leq 0.5 \cdot {log}_{2} \vert {A}_{2} \vert , & ( 36 ) \\ {J}_{I} ( {\hat{s}}_{1} , k , j ) = γ \cdot {LUT}_{I} ( \frac{{β}_{I} ( {\hat{s}}_{1} )}{γ} , k , j ) , j > 0.5 \cdot {log}_{2} \vert {A}_{2} \vert . & ( 37 )\end{matrix}$$

By employing look-up tables, the minimum costs have been found while effectively computing only one instance of the cost functions C_{R}(ŝ₁,ŝ_{2,R}) or C_{I}(ŝ₁,ŝ_{2,I}). It should be appreciated that these look-up tables can be viewed as an alternative—or specialized—set of pre-defined rules to the ones provided herein with respect to R-DC. The two techniques (using a look-up table and using a predefined set of rules) both use sets of pre-defined rules for computing the minimum cost function, although such sets of rules are clearly very different.

Finally, the LLR values are computed according to equation (17). The reduced size of the look-up tables makes such embodiments low complexity. The size of these look-up tables is reduced because the input can be restricted to the range around the possible values of s_{2,R} and s_{2,I}.

Note that the factor γ (the norm) is common to all the terms in the minimizations; the Max-Log detector can therefore extract a factor, such as factor γ, from the kernel computation to reduce complexity further and then compensate for the extracted factor during the LLR computation by returning the factor when computing the LLR, in which case the equations for computing the kernels and the LLR values are modified as follows:

$$\begin{matrix}{J}_{R} ( {\hat{s}}_{1} , k , j ) = {LUT}_{R} ( \frac{{β}_{R} ( {\hat{s}}_{1} )}{γ} , k , j ) , j \leq 0.5 \cdot {log}_{2} \vert {A}_{2} \vert , & ( 38 ) \\ {J}_{I} ( {\hat{s}}_{1} , k , j ) = {LUT}_{I} ( \frac{{β}_{I} ( {\hat{s}}_{1} )}{γ} , k , j ) , j > 0.5 \cdot {log}_{2} \vert {A}_{2} \vert , & ( 39 ) \\ {λ}_{i , j} = \{ \begin{matrix}γ \cdot ( {min}_{{\hat{s}}_{1} ∈ {A}_{1} ( 0 , j )} ( \frac{α ( {\hat{s}}_{1} )}{γ} + {J}_{M} ( {\hat{s}}_{1} ) ) - {min}_{{\hat{s}}_{1 ∈ {A}_{1} ( 1 , j )}} ( \frac{α ( {\hat{s}}_{1} )}{γ} + {J}_{M} ( {\hat{s}}_{1} ) ) ) & if i = 1 \\ γ \cdot ( {min}_{{\hat{s}}_{1} ∈ {A}_{1}} ( \frac{α ( {\hat{s}}_{1} )}{γ} + {J}_{RI} ( {\hat{s}}_{1} , 0 , j ) ) - {min}_{{\hat{s}}_{1 ∈ {A}_{1}}} ( \frac{α ( {\hat{s}}_{1} )}{γ} + {J}_{RI} ( {\hat{s}}_{1} , 1 , j ) ) ) & if i = 2\end{matrix} . & ( 40 )\end{matrix}$$

Embodiments of a Max-Log detector 100 implemented as disclosed above can be adjusted to fit a variety of special cases of the channel model, some illustrative examples of which follow. In all embodiments, it is preferred that the effective channel model has N inputs and N outputs, where N is an integer. Before MIMO processing begins the signal is modeled as:

\tilde{r}=\tilde{H}\tilde{s}+\tilde{w}, (41)

where \tilde{H} is an M×N matrix, \tilde{s}=[\tilde{s}₁ \tilde{s}₂ . . . \tilde{s}_{N}]^{T} is an N dimensional vector of symbols that may be drawn from different alphabets, and \tilde{w} is additive white noise with

$$E [ \tilde{w} {\tilde{w}}^{*} ] = [ \begin{matrix}{σ}_{1} & 0 \\ 0 & {σ}_{2}\end{matrix} ] .$$

For cases where the autocorrelation of the true additive noise has non-zero off-diagonal components,

$$E [ \tilde{w} {\tilde{w}}^{*} ] = [ \begin{matrix}{σ}_{1 , 1} & {σ}_{1 , 2} \\ {σ}_{2 , 1} & {σ}_{2 , 2}\end{matrix} ] ,$$

the channel can be made to fit the above channel model by first scaling the channel outputs. For example, and not by way of limitation, a scaling matrix F can be chosen and applied to the channel output so that the new effective channel output is described as \tilde{r}=F\tilde{H}\tilde{s}+F\tilde{w}, such that

$$E [ F \tilde{w} {\tilde{w}}^{*} {F}^{*} ] = [ \begin{matrix}{σ}_{1} & 0 \\ 0 & {σ}_{2}\end{matrix} ] ;$$

see for example, and not by way of limitation, U.S. patent application Ser. No. 12/022,927 for “Systems and Methods for Scaling to Equalize Noise Variance”. It should be appreciated that in this discussion it is assumed that such processing, if necessary, has already been done so that the channel model fits equation (41) and

$$E [ \tilde{w} {\tilde{w}}^{*} ] = [ \begin{matrix}{σ}_{1} & 0 \\ 0 & {σ}_{2}\end{matrix} ] .$$

Some special examples of converting this M×N channel into an N×N channel are given below.

H is complex. If M=N, obviously no conversion is necessary to obtain a square channel matrix. At least some of Max-Log detector 100 embodiments were derived assuming that the channel matrix is square and contains only complex coefficients. When H is complex:

H=\tilde{H}, (42)

r=\tilde{r}. (43)

H is triangular with real diagonals. The channel matrix is triangular (either lower or upper) when a decomposition, such as a QR decomposition, is used to transform the channel. The QR decomposition is defined as:

\tilde{H}=QR, (44)

where Q is an M×N matrix with orthonormal columns, and R is an N×N triangular matrix with real diagonal elements. This results in:

r=Q*\tilde{r} (45)

H=R (46)

In this special case, the direct computation method can be reduced to use the look-up tables from equations (34) and (35) by using the following definitions:

$$\begin{matrix}α ( {\hat{s}}_{1} ) = {w}_{1 , 1} {\vert {y}_{1} ( {\hat{s}}_{1} ) \vert}^{2} , & ( 47 ) \\ {C}_{R} ( {\hat{s}}_{1} , {\hat{s}}_{2 , R} ) = {w}_{2 , 2} {h}_{2 , 2}^{2} {\vert {\hat{s}}_{2 , R} - \frac{{y}_{2 , R} ( {\hat{s}}_{1} )}{{h}_{2 , 2}} \vert}^{2} , & ( 48 ) \\ {C}_{I} ( {\hat{s}}_{1} , {\hat{s}}_{2 , I} ) = {w}_{2 , 2} {h}_{2 , 2}^{2} {\vert {\hat{s}}_{2 , I} - \frac{{y}_{2 , I} ( {\hat{s}}_{1} )}{{h}_{2 , 2}} \vert}^{2} . & ( 49 )\end{matrix}$$

Equations (47)-(49) demonstrate that a fully enumerated 2×2 CLIC detector [such as disclosed in U.S. patent application Ser. No. 11/930,259 for “Candidate List Generation and Interference Cancellation Framework for MIMO Detection,” is a special implementation of Max-Log detector embodiments.

H is triangular and monic. The channel matrix can be triangular and monic (meaning the channel matrix has ones along the diagonal) by filtering \tilde{r} using both Q and R from the QR decomposition. Let r_{i,j} denote the element at the i-th row and j-th column of R. Then the effective channel model is obtained as follows:

$$\begin{matrix}r = {[ \begin{matrix}{r}_{1 , 1} & 0 \\ 0 & {r}_{2 , 2}\end{matrix} ]}^{- 1} Q * \tilde{r} , & ( 50 ) \\ H = {[ \begin{matrix}{r}_{1 , 1} & 0 \\ 0 & {r}_{2 , 2}\end{matrix} ]}^{- 1} R = [ \begin{matrix}1 & 0 \\ \frac{{r}_{2 , 1}}{{r}_{2 , 2}} & 1\end{matrix} ] or [ \begin{matrix}1 & \frac{{r}_{1 , 2}}{{r}_{1 , 1}} \\ 0 & 1\end{matrix} ] , & ( 51 )\end{matrix}$$

H is real. When the channel is real, complexity diminishes significantly at least because the channel matrix has half as many coefficients. Besides a physical channel that is real, there are other scenarios where the channel would be real. For example, in an ultra-wideband (UWB) system, data may be transmitted in a redundant fashion by using two different sub-carriers to simultaneously transmit a function of the same two data symbols; see for example and not by way of limitation, U.S. provisional patent application Ser. No. 60/912,487 for “Dual-Carrier Modulation (DCM) Encoder-Decoder for Higher Data Rate Modes of WiMedia PHY”. In such an embodiment, the MIMO channel may be written as:

\tilde{r}=GTs+\tilde{w}, (52)

where

$$G = [ \begin{matrix}{g}_{1} & 0 \\ 0 & {g}_{2}\end{matrix} ]$$

is a 2×2 matrix with complex diagonal elements, and Ts is the vector of transmitted symbols. The 2×2 matrix T mixes the two symbols s₁ and s₂ so that pieces of both are transmitted on the two sub-carriers. An example T matrix is

$$T = \frac{1}{\sqrt{17}} [ \begin{matrix}4 & 1 \\ 1 & - 4\end{matrix} ] .$$

The MIMO channel matrix can be taken as H=GT, but that approach forms a complex channel. Alternatively, the signal can be equalized using G*:

$$\begin{matrix}r = G * \tilde{r} \\ = G * GTs + G * \tilde{w} ,\end{matrix} \qquad ( 53 )$$

With such an equalization, the effective MIMO channel matrix is real when the matrix T is real, meaning:

$$H = G * GT = [ \begin{matrix}{\vert {g}_{1} \vert}^{2} & 0 \\ 0 & {\vert {g}_{2} \vert}^{2}\end{matrix} ] T \qquad ( 54 )$$

H has real diagonals. The MIMO channel may alternatively have some real coefficients and some complex coefficients. This would happen, for example and not by way of limitation, if M=N and the receiver uses an equalizer that is the conjugate of the diagonals of the channel matrix. In such an embodiment:

$$\begin{matrix}r = [ \begin{matrix}{\tilde{h}}_{1 , 1}^{*} & 0 \\ 0 & {\tilde{h}}_{2 , 2}^{*}\end{matrix} ] \tilde{r} , & ( 55 ) \\ H = [ \begin{matrix}{\vert {\tilde{h}}_{1 , 1} \vert}^{2} & {\tilde{h}}_{1 , 1}^{*} {\tilde{h}}_{1 , 2} \\ {\tilde{h}}_{2 , 2}^{*} {\tilde{h}}_{2 , 1} & {\vert {\tilde{h}}_{2 , 2} \vert}^{2}\end{matrix} ] , & ( 56 )\end{matrix}$$

Another example of this case is when the channel is complex and M>N, then a simple conversion can be used:

r=\tilde{H}^{H}\tilde{r}, (57)

H=\tilde{H}^{H}H, (58)

where \tilde{H}^{H} is the conjugate transpose of \tilde{H}. So although the effective channel processed by the Max-Log detector is N×N, it should be appreciated that the underlying MIMO channel need not have the same number of inputs as outputs.

Many modifications and other embodiments of the invention will come to mind to one skilled in the art to which this invention pertains having the benefit of the teachings presented in the foregoing descriptions, and the associated drawings. Therefore, it is to be understood that the invention is not to be limited to the specific embodiments disclosed. Although specific terms are employed herein, they are used in a generic and descriptive sense only and not for purposes of limitation.

What is claimed is:

1. A multiple-input, multiple-output (MIMO) system, comprising:
a Max-Log detector which computes a set of log-likelihood ratio (LLR) values for a channel input by minimizing a cost function while computing only one instance of the cost function for each value of each bit in a symbol.

2. The system of claim 1, wherein the Max-Log detector minimizes the cost function by computing real and imaginary kernels according to a predefined set of rules.

3. The system of claim 1, wherein the Max-Log detector minimizes the cost function by computing real and imaginary kernels by using a slicer to find a symbol that minimizes the cost of at least a portion of the channel input.

4. The system of claim 1, wherein an effective channel model for the channel input has N inputs and N outputs, where N is an integer.

5. The system of claim 1, wherein real and imaginary parts of the channel input have been mapped to different bits.

6. The system of claim 5, wherein the mapping is performed using one from the group of: Gray coding and dual-carrier modulation (DCM).

7. The system of claim 1, wherein the Max-Log detector computes γ, ρ, and β before minimizing a cost function, where β is a cross-product, γ is a norm, and ρ is a local norm.

8. The system of claim 7, wherein γ is computed only once.

9. The system of claim 1, wherein the Max-Log detector computes α, J_{RI} and J_{M} for each of at least one value of a symbol and tracks minimum values for each bit, where α is a first layer norm, J_{RI} is a local minimum for a symbol, and J_{M} is a bit-level local minimum for the symbol.

10. The system of claim 9, wherein the Max-Log detector computes α, J_{RI} and J_{M} using direct computation.

11. The system of claim 9, wherein the Max-Log detector computes α, J_{RI} and J_{M} using a lookup table-based method.

12. The system of claim 9, wherein the Max-Log detector computes α as equal to ρ, where the value of ρ is a local norm.

13. The system of claim 9, wherein the Max-Log detector computes α, J_{RI} and J_{M} for all possible values of a symbol and tracks minimum values for each bit.

14. The system of claim 1, wherein the Max-Log detector further extracts a factor from all kernels prior to minimizing the cost function, and then compensates for the extracted factor to compute the LLR.

15. The system of claim 1, wherein the Max-Log detector is a modified Max-Log detector.
